(19) United States
(12) Patent Application Publication
(10) Pub. No.: US 2005/0001422 A1
(43) Pub. Date: Jan. 6, 2005

(54) Printable intermediate construction incorporating registrably positioned laminate components that can be imaged and then easily formed into a laminated card or decal on demand

(76) Inventors: Robert V. O'Keefe, Stillwater, MN (US); Andrew J. Stoick, Minneapolis, MN (US); Danny D. Thaden, Forest Lake, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/830,703

(22) Filed: Apr. 23, 2004

Related U.S. Application Data
(60) Provisional application No. 60/465,597, filed on Apr. 25, 2003.

(51) Int. Cl. B42D 15/00

(52) U.S. Cl. 283/98

(57) ABSTRACT

A card intermediate having a carrier comprising a fold line defining first and second panels, the first and second panels having provided thereon first and second respective card portions that are in a spaced apart relationship with the fold line. Because of the spaced apart relationship of the card portions, the card intermediate may be more easily manufactured, and further, is more easily formed into a laminated card with excellent precision.

### CROSS-REFERENCE TO RELATED APPLICATIONS

The present non-provisional Application claims the benefit of commonly owned provisional Application having Ser. No. 60/465,597, filed on Apr. 25, 2003, and entitled PRINTABLE INTERMEDIATE CONSTRUCTION INCORPORATING REGISTRABLY POSITIONED LAMINATE COMPONENTS THAT CAN BE IMAGED AND THEN EASILY FORMED INTO A LAMINATED CARD OR DECAL ON DEMAND, which Application is incorporated herein by reference in its entirety.

### FIELD OF THE INVENTION

The present invention relates to a printable intermediate construction, methods of making the intermediate, and methods of forming the intermediate into a laminated card or decal, such as ID card, driver's license, window sticker, or the like.

### BACKGROUND OF THE INVENTION

Indicia-bearing, laminated forms are widely used by a variety of businesses and governmental entities to provide their customers or citizens with many forms of identification or other documentation, such as membership and identification cards, drivers licenses, parking decals, license tabs, and the like. Such forms, indeed ubiquitous in everyday life, typically comprise many layers of differing materials in which printed information is printed onto one or more layers. The information typically can be human or machine readable. The information can be printed on the card surface or can be “buried” on one or more inner card layers. Buried information may be preferred in some instances inasmuch as overlying layer(s) protect the information from wear and tampering.

Business forms for making laminated identification cards on demand have been developed. Typically, these contain card portions supported on a carrier. In use, desired printing is applied to the form on demand after which the form is folded to laminate the portions together. The resultant laminated construction can then be removed. See, e.g., U.S. Pat. Nos. 6,305,717; 5,915,733; 5,543,201; and 5,518,787; and PCT publication WO 01/02191.

In order to produce the laminated card, the business, governmental entity, customer or citizen, typically must remove one or more layers from a portion of the laminated form, fold the remaining layers into registered contact with each other and remove the card from a backing material. If the final card is formed by the business or governmental entity, it is typically so formed utilizing expensive automated systems. If formed by customers or citizens, the forms must typically also comprise alignment mechanisms, such as embossments, so that the desired precision in card formation can be achieved. Each of these forming steps, in addition to requiring additional manufacturing steps or expenditure, may also be suboptimal in that the desired level of precision in card formation is often not achieved.

Desirably, such laminated forms would be printable using readily accessible print technology so that the forms could be printed economically and on-demand. Indeed the ability to print using at least laser or inkjet technology would be highly desirable inasmuch as such printers are not only very reasonably priced and widely available, but are also capable of printing images or other indicia with a high level of detail, so that color photographs, complicated graphics, one or two dimensional or multidimensional bar coding and the like could be provided on the forms singly or in combination. The ability to provide such high detail images or indicia, in turn, provides the ability to produce forms with varying levels or numbers of security measures and further, the ability to provide the forms on-demand and at low cost. Unfortunately, either due to incompatibility of the materials used therein with a color, dot matrix printing process, or the fact that many conventional forms can have varying thicknesses, many currently available forms are not as easily printable or as useable with such technology as might be desired.

Clearly, for many, if not all, applications of such card forms, the resulting card or decal is desirably tamper resistant, so that the information printed thereon is substantially secure and reliable for its intended purpose. Tamper resistance, in turn, can be provided at least by utilizing suitable fixed indicia and/or variable indicia, as well as by utilizing a complex card structure, by the utilization of substantially permanent adhesive in the card formation, and the like. However, as discussed above, conventional card forms are not easily printed with complex, detailed information, often requiring the use of expensive, centralized equipment to do so.

It would thus be desirable to provide an intermediate construction that may be easily formed into a final laminated card or decal without the use of expensive equipment. Desirably, the card or decal so formed could be formed precisely, i.e., so that the card portions are securely laminated to each other and so that the edges or periphery thereof would be substantially uniform. It would further be desirable to provide such an intermediate construction that further may have provided thereon any desired indicia, fixed or variable, of any number and complexity, while yet still allowing card or decal production therefrom on-demand and at a low cost. Finally, such an intermediate construction would desirably be capable of being used to produce a laminated card or decal that is substantially tamper resistant, so that the indicia printed thereupon has sufficient integrity for its intended purpose.

### SUMMARY OF THE INVENTION

The present invention relates to an intermediate form, methods of making the intermediate form, and methods of using the intermediate form to produce a laminated card, decal, or the like. More particularly, the present invention provides an intermediate form having a carrier comprising, among other things, a fold line defining first and second panels. First and second, releasable card portions are supported upon and/or within the first and second panels, respectively. The card portions are registrably positioned in spaced apart relationships with the fold line. Any kind of desired indicia, e.g., text, graphics, logos, patterns, watermarks, other security indicia, photographs, bar codes, biometric codes, and the like may be printed or otherwise imaged onto one and/or both card portions. When the construction is closed, the card portions registrably mate and can be laminated to each other. The finished card is then removed from the construction. Carrier portions may or may not be incorporated into one or both card portions. The indicia are then visible through one or both faces of the resultant, laminated card.

Because of the spaced apart, registrable relationship of the card portions with respect to the fold line, the manufacture and use of the intermediate is simplified. A further advantage of the spaced apart, registrable relationship of the card portions is that the intermediate may be readily formed into a laminated card or decal without the use of expensive automation, and yet the edges or periphery of the resulting card may be registrably brought together with high precision. The spaced apart relationship of the first and second card portions increases the accuracy of registrably folding the intermediate at least because the folding action is initiated prior to the card portions coming into contact. Additionally, because little, if any, card portion material overlies the fold line these materials do not substantially interfere with the folding process, to the extent that the presence of any amount of these materials may otherwise do so. Finally, the first and second card portions are readily and easily accurately provided in a spaced apart relationship with the fold line, so that once the fold is initiated and completed, the registered contact of the card portions is easily achieved.

The spaced apart relationship of the first and second card portions may also provide certain advantages in the manufacture of the intermediate. In particular, because the first and second card portions are spaced apart from the fold line, the manufacturing tolerances associated with depositing different materials over the card portions may actually be eased. Specifically, card portion material(s) for each card portion are provided onto the carrier on appropriate side of the fold line. The card portions themselves are then formed in the material, such as by die cutting, after at least some of the material(s) are deposited on the carrier. So long as the card portions themselves are accurately formed with respect to the desired fold line, the placement of the material(s) is not critical. In other words, the tolerances for depositing the material(s) onto the carrier are greatly eased in the practice of the present invention.

In certain embodiments of the invention, one or both of the card portions of the intermediate may comprise a material that is, or may be coated or treated to be, printable using inkjet, laser technology, or other desired printing technology so that printed information may be produced on the inventive intermediate economically and on-demand.

In a first aspect then, the present invention provides a card intermediate, wherein the intermediate comprises a carrier comprising an upper and a lower surface and a fold line defining first and second panels. The intermediate further comprises at least one first card portion and at least one second card portion. The at least one card portion includes imprintable material and is provided on the first panel such that the at least one card portion is spaced apart from the fold line. The at least one second card portion includes at least partially transparent material having an upper surface and lower surface and is provided on the second panel such that the at least one second card portion is spaced apart from the fold line in a position such that the second card portion registrably contacts the first card portion when the carrier is closed along the fold line. At least one of the card portions bears an adhesive to allow lamination of the first and second card portions to each other. In certain embodiments of the invention, the imprintable material may desirably be ink receptive material, such as being printable by inkjet or laser printing techniques. This provides the further advantage that the intermediate may be inexpensively printed on-demand, and yet have provided thereon color images, or other images having a high level of detail. In certain other embodiments of the invention, the card intermediate includes first and second card portions such that when the first card portion mates with the second card portion to provide a card, the card portions mate so as to form a water resistant seal.

In a further aspect then, the present invention provides a method of making a card intermediate. Generally speaking, the method comprises the steps of applying a first and a second strip of material onto an upper surface of a carrier supply in first and second positions, respectively.

Both strips generally extend along a length of the carrier, and are generally parallel to each other. A reference line, e.g., a fold line, is determined along a length of the carrier supply so that at least portions of each of the first and second strips of material are positioned on different sides of the reference line. At least one die cut is formed through each of the first and the second strips of material to define at least one first and second card portion, respectively, wherein each card portion is spaced apart from the fold line so that the second card portion is registrably spaced apart from the fold line with respect to a corresponding first card portion. Before or after the die cuts have been formed, fixed and/or variable indicia can be provided on the card portions as desired. In certain embodiments, a plurality of die cuts are formed through the first and second strips of material to define a plurality of first and second card portions, respectively, wherein each plurality of card portions is spaced apart from the fold line so that each of the second card portions is registrably spaced apart from the fold line with respect to the corresponding first card portion. In such embodiments, before or after the die cuts have been formed, the carrier supply can be divided into a plurality of card intermediates, each card intermediate having at least one first card portion and at least one corresponding second card portion. Optionally, the excess material or weed between card portions can be removed from the carrier. In certain preferred embodiments, one strip of material is desirably an ink receptive material, so that the step of providing fixed and/or variable indicia within the card portion comprising the ink receptive material can be performed on-demand, with a commercially available printer, such as an inkjet printer. The other strip of material is at least partially transparent and serves, in one aspect, as a protective coverlay over the other strip when the card portions are laminated together.

In a further aspect of the invention, there is provided a method of making a laminated card. Generally speaking, the method comprises the steps of providing a card intermediate as described herein. Visually discernible information is provided on at least one of the first and second card portions, and the carrier folded along the fold line under conditions so that the first card portion is registrably laminated to the second card portion to form the laminated card. The laminated card is then removed from at least a portion of the carrier.

### BRIEF DESCRIPTION OF THE DRAWINGS

The accompanying drawings, which are incorporated in and constitute a part of this application, illustrate several aspects of the invention and together with description of the embodiment reserve to explain the principles of the invention. A brief description of the drawings is as follows:

FIG. 1 is a perspective, schematic view of an intermediate embodying features of the present invention;

FIG. 2 is a transverse, schematic cross-sectional view of the intermediate of FIG. 1, taken at line 2-2;

FIG. 3 is a schematic cross-sectional side view showing the construction of FIG. 1 folded to bond first and second card portions together;

FIG. 4 shows the resultant laminated card of FIG. 3 being removed from the remainder of the carrier;

FIG. 5 is a schematic perspective view of an alternative embodiment of an intermediate construction form of the present invention;

FIG. 6 shows a schematic of an intermediate according to the design of FIG. 1;

FIG. 7 shows the intermediate of FIG. 6 after indicia has been printed onto an ink receptive surface of the first card portion of the intermediate;

FIG. 8 shows the intermediate of FIG. 7 after folding;

FIG. 9 shows the folded intermediate of FIG. 8 after lamination to form a laminated card still supported within the first panel of the carrier and after the second panel portion of the carrier proximal to the second card portion has been peeled away and removed;

FIG. 10 shows the resultant laminated card of FIG. 9 after removal from the remainder of the carrier;

FIG. 11 is a schematic perspective view of an alternative embodiment of an intermediate construction form of the present invention;

FIG. 12 is a schematic, side cross-sectional view of the construction of FIG. 11 taken along line 12-12;

FIG. 13 shows a schematic, side, cross-sectional view of the intermediate of FIG. 12 folded to bring the first and second card portions registrably together;

FIG. 14 shows a schematic, side, cross-sectional view of the resultant laminated card formed from FIG. 13;

FIG. 15 shows a schematic, perspective view of the resultant laminated card formed in FIG. 14 being removed from the carrier;

FIG. 16 shows a schematic, perspective view of the resultant laminated card formed in FIG. 14;

FIG. 17 shows a pre-printed subassembly comprising a protective backside cover overlying a body portion that will be used to form first card portions with respect to the intermediate of FIGS. 11-16;

FIG. 18 shows an alternate view of the pre-printed subassembly in FIG. 17;

FIG. 19 shows an alternate view of the pre-printed subassembly in FIG. 17;

FIG. 20 shows a peeled away portion of the protective backside from the pre-printed subassembly in FIG. 17;

FIG. 21 shows a pre-printed, ink receptive body material that will be used to form first card portions with respect to the intermediate of FIGS. 27 and 28;

FIG. 22 shows how the ink receptive body material of FIG. 21 and the subassembly of FIGS. 17-20 would be positioned to laminate one to the other;

FIG. 23 shows the assembly of FIG. 22 with a plurality of die cuts having been made through the ink receptive body material and the resulting weed has been removed;

FIG. 24 shows a close up of one end of the die cut subassembly of FIG. 23;

FIG. 25 shows the die-cut assembly of FIG. 23 supported on a carrier;

FIG. 26 shows a pre-printed length of material from which second card portions will be formed with respect to the intermediate of FIGS. 27 and 28;

FIG. 27 shows the material of FIG. 26 supported on the carrier of FIG. 25;

FIG. 28 shows a portion of the carrier assembly of FIG. 27 after die cutting and perforating to define first card portions, second card portions, and the fold line between them, with portions of the resulting weed removed showing the card portions left on the carrier;

FIG. 29 shows an intermediate formed from the assembly of FIG. 28;

FIG. 30 shows indicia printed onto the ink receptive surface of the intermediate of FIG. 29;

FIG. 31 shows the intermediate of FIG. 30 in a folded state in which the first and second card portions are registrably mated;

FIG. 32 shows the resultant laminated card after the folded intermediate of FIG. 31 has been passed through a laminating device and removed from the carrier;

FIG. 33 shows a perspective view of the front side of the card of FIG. 32;

FIG. 34 shows a perspective view of the backside of the card of FIG. 32; and

FIG. 35 shows a schematic, side cross-sectional view of an alternative intermediate embodiment of the present invention.

### DETAILED DESCRIPTION OF EMBODIMENTS OF THE INVENTION

The embodiments of the present invention described below are not intended to be exhaustive or to limit the invention to the particular embodiments disclosed in the following detailed description. Rather, the embodiments are described so that others skilled in the art understand the principles and practices of the present invention.

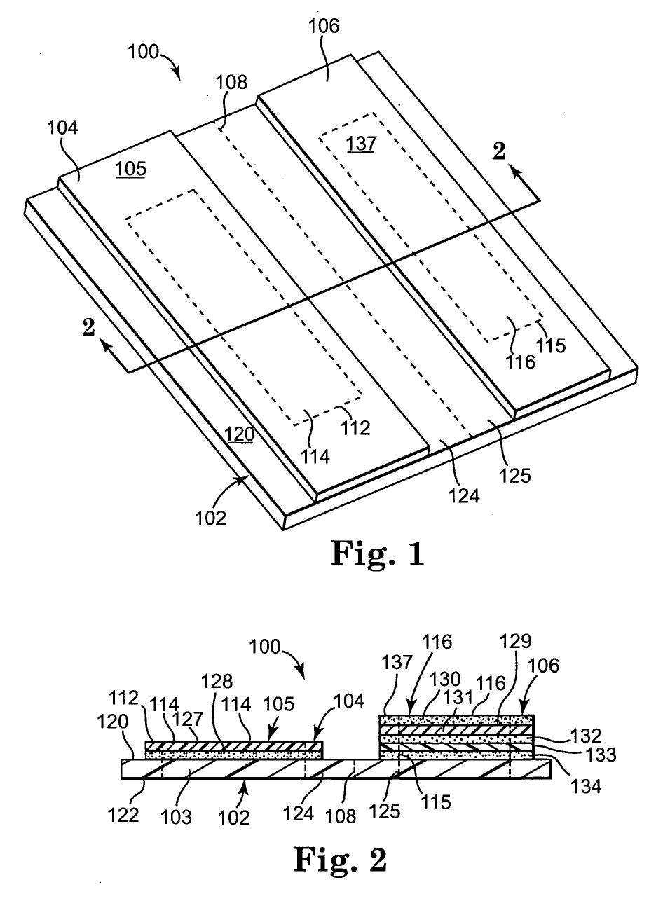

Referring now to FIGS. 1 and 2, there is illustrated one embodiment of an intermediate construction 100 in accordance with the present invention. Generally, intermediate construction 100 comprises carrier 102 having upper surface 120 and lower surface 122. Carrier 102 may be visually transparent, partially transparent, or opaque as desired. Carrier 102 may be any size that is suitable for supporting card portions 114 and 116 and that is capable of being used with any desired printing techniques, such as ink jet or laser printer techniques.

Carrier 102 may be comprised of any film or sheet material, or combination or laminate of materials, either rigid or flexible, so long as carrier 102 has sufficient strength to support card portions during handling and intended use and, in this particular embodiment, to form a part of the resultant card or decal to help ensure that the card or decal formed from intermediate 100 is sufficiently durable for its intended use.

Film and/or sheet materials suitable for use as carrier or any of the other film or sheet materials described herein may be any of those conventionally used in the manufacture of business forms and laminated cards, such as single ply or multiply polymer films, card stock, paper stock, etc. Examples include paper, paper stock, cardboard, polyester, fluoropolymers, olefins such as polypropylene and polyethylene, polycarbonate, polyamine, polyamide, poly(meth)acrylic, polyurethane, cellulosic material, metal foil, combinations of these and the like. Such materials may include iridescent, retroreflective, color, holographic, fluorescent, or other characteristics (which may be integral or otherwise incorporated into or onto the material), as desired.

Optionally, the carrier and any of the other lamina or laminated components of the intermediate 100 may be formed from constituent layers and/or purchased in pre-constructed form from commercial sources such as 3M Company, Fasson which is a business unit of Avery Dennison Corp., Transilwrap Co., Inc., Mactac which is a business unit of the Bemis Co., Castcal which is a business unit of Computype, Inc., and the like. These pre-constructions typically may be sold with removeable and discardable release liners to protect otherwise exposed adhesive surfaces or the like until such pre-constructions are to be used.

A reference line in the form of fold line 108 generally extends along a length of carrier 102 and thereby defines first panel 124 and second panel 125. Fold line 108 may be provided in any form, or by any mechanism, so long as the presence of fold line 108 at least minimally assists in the accurate folding (described further below) of carrier 102. For example, fold line 108 may be a thin line where the thickness of carrier 102 is reduced, either continually, as may be caused to occur by scoring carrier 102, or intermittently, as may be caused to occur by perforating carrier 102.

First panel 124 has incorporated in, applied thereupon, or otherwise formed thereon, a body 104 of material including an imprintable surface 105. Second panel 125 has incorporated in, applied thereupon or otherwise formed thereon a body 106 formed from material(s) such that body 106 is at least partially transparent to allow indicia on surface 105 to be viewed when card portions 114 and 116 are laminated together. Bodies 104 and 106 are thus positioned on opposite sides of fold line 108. The exact positioning of bodies 104 and 106 with respect to fold line 108 is not critical. In fact, in the practice of the present invention, there is much latitude in positioning these bodies 104 and 106 on carrier 102, easing manufacturing. However, it is preferred that each body 104 and 106 is spaced from fold line 108 at least to some degree so that bodies 104 and/or 106 do not unduly interfere with the folding action of intermediate construction 100.

Body 104 may be formed from any material(s) so long as at least a portion of surface 105 is print receptive, i.e., capable of being imaged using any conventional imaging or printing technique, such as thermographic imaging, laser, inkjet or screen printing, spraying, application of a decal, painting by brush or roller, any electrostatic printing or thermal transfer process and the like. Advantageously, body 104 will be capable of being imaged by any desired printing technique, and most advantageously, will be capable of being imaged by an ink-jet and/or laser printer.

In the embodiment shown in FIGS. 1 and 2, body 104 is formed from an ink receptive film or sheet layer 127 and adhesive layer 128. Film layer 127 may be transparent, partially transparent, or opaque depending upon the nature of the card to be formed. Adhesive layer 128 preferably comprises a permanent adhesive to durably adhere printable material 127 to carrier 102 in this particular embodiment because carrier portion 103 is a constituent of card portion 114. Otherwise, adhesive layer 128 may comprise a releasable adhesive to allow card portion 114 to be released from carrier 102 when desired. Optionally, body 104 is conveniently purchased in pre-constructed form from a suitable source.

Body 106 may be formed from one or more material(s) such that body 106 is at least partially transparent so that when intermediate 100 is formed into a laminated card 150 by bringing first and second card portions 114 and 116, respectively, into a registered and confronting relationship, visually discernible indicia printed or otherwise provided on card portion 114 may be discerned through body 106. Visually transparent material 106 may also desirably be of sufficient strength so as to be able to minimally protect the integrity of such indicia from wear, tampering, and/or the like. Preferably body 106 is generally a multilayer construction including heat sealable (optionally being ink receptive) adhesive layer 130, at least partially transparent film or sheet 131, releasable adhesive layer 132, film or sheet layer 133, and permanent adhesive layer 134. Conveniently, pre-constructions of layers 130 and 131, as well as of layers 132, 133, and 134 are readily obtained from commercial sources, respectively.

Heat sealable adhesive layer 130 thus is provided on at least a portion of an upper surface 129 of visually transparent material 131. As such, when intermediate 100 is folded about fold line 108 in order to bring first card portion 114 into registered contact with second card portion 116, adhesive layer 130 can be caused to adhere first card portion 114 and second card portion 116 together. Although adhesive layer 130 preferably may comprise any heat sealable adhesive capable of adhering two materials together, adhesive layer 130 optionally may comprise other kinds of adhesive characteristics, such as a pressure sensitive adhesive (PSA), that preferably provide a permanent bond that minimally will provide evidence of any attempted tampering with a laminated card or decal (e.g., card 150) formed from intermediate 100.

In applications where maximum security is desirable, adhesive layer 130 advantageously may comprise a heat sealable adhesive so that, once adhesive layer 130 is brought into contact with first card portion 114 and heated, first card portion 114 will be substantially incapable of being removed from second card portion 116 without damage to the card, thus evidencing tampering. Heat sealable adhesives also may provide water resistant or waterproof bonds to help protect printed indicia from water and humidity. Heat sealable adhesives also are easier to handle at room temperature and generally do not demonstrate tacky characteristics until heated to an elevated temperature. For laser and inkjet applications, such temperature is desirably greater than the highest printing temperature to avoid developing undue tackiness during printing.

Bodies 104 and 106 have die-cuts 112 and 115, respectively, provided therein. Die-cut 112 defines first card portion 114 within body 104, and die-cut 115 defines second card portion 116 within body 106. Die-cut 112 further extends through carrier 102 to define carrier portion 103 which is intended to be a constituent of first card portion 114. However, as shown, die-cut 115 preferably does not extend through carrier 102. In other embodiments, portions of carrier 102 may or may not be constituents of first card portion 114 and/or second card portion 116. Fixed and/or variable indicia (not shown) of any desired form or variety may be provided on first card portion 114 and optionally second card portion 116. Such indicia may also be provided on lower surface 122 of carrier 102, if desired, although the same is not illustrated in FIG. 1. Generally and preferably, first card portion 114 functions as the base of the resultant card on which a substantial portion of fixed and variable information is printed on demand, while second card portion 116 functions as a protective, at least partially transparent cover of the resultant card to protect the indicia from wear and tampering. Die-cuts 112 and 115 may be of any configuration, and may be provided in any fashion. Preferably, die-cuts 112 and 115 may be perforations, score lines or the like.

Due at least in part to the spaced apart relationship of first and second card portions 114 and 116, respectively, relative to fold line 108, intermediate 100 may be readily and easily formed into laminated card 150 without the use of automated equipment, or the provision of expensive and/or complex alignment features on intermediate 100. In the preferred embodiments described herein, card portion material does not overly the fold line, thereby increasing folding accuracy. It is also easier to accurately fold the intermediate construction without misalignment and/or bubbles since the fold is initiated before the card portions contact each other. Thus, their positioning onto the carrier 102 is more easily and quickly carried out than if tighter placement tolerances had to be followed.

Intermediate construction 100 is easily used to prepare a laminated card or decal. Generally speaking, the method comprises the steps of providing a card intermediate as described hereinabove in connection with FIGS. 1 and 2. Intermediate 100 may be provided initially, with or without fixed or variable indicia provided thereupon, but in any case is readily imaged or printed upon demand.

Any desired indicia, such as text, patterns, graphics, bar codes, biometric codes, photographs, or the like, may be applied to first card portion 114 and/or second card portion 116 on demand. Advantageously, imprintable surface 105 as described above, may desirably and advantageously be printable by laser printing or inkjet printing techniques, so that intermediate construction 100 may be printed upon quickly, on-demand at any desired location using inexpensive printing equipment. Inkjet printing is particularly advantageous in that indicia including not just text but also color images, e.g., photographs, may be printed upon intermediate 100 while yet being capable of being produced in an on-demand fashion.

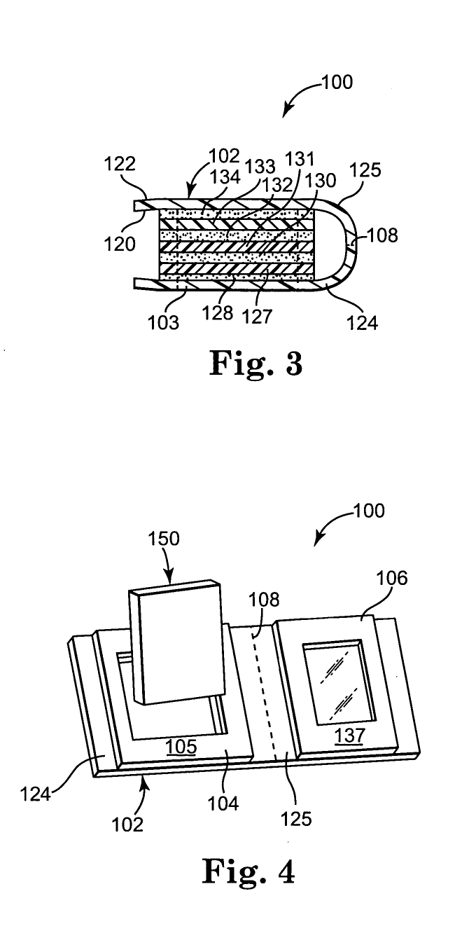

Once the desired indicia are applied, the intermediate construction 100 is folded along the fold line so that the first card portion 114 is registrably brought into contact with second card portion 116, and then the two portions are bonded to form the laminated card or decal (See FIG. 3). If adhesive layer 130 contains a PSA, pressure is all that is needed to bond. If adhesive layer 130 includes a heat sealing adhesive, heat and optionally pressure may be used to achieve bonding. Simple, widely available, relatively inexpensive lamination equipment may be used to accomplish lamination when a heat sealable adhesive is used. The resultant laminated card or decal 150 may then be removed from at least a portion of the carrier. The remaining portion of carrier 102, also known as a ‘weed’ to those of ordinary skill in the art, may be discarded (See FIG. 4).

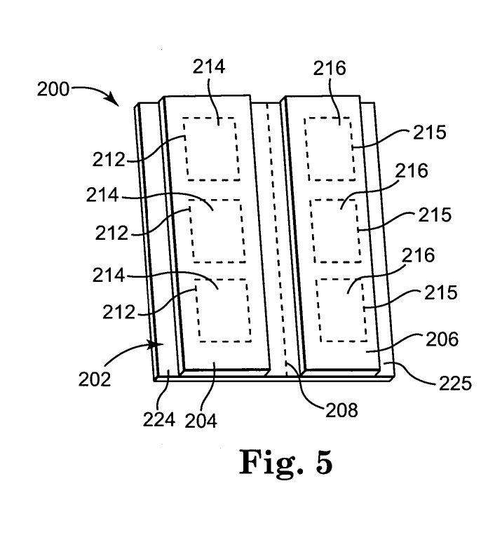

Turning now to FIG. 5, there is illustrated an alternative intermediate construction 200 embodying features of the present invention. Features similar to those described in connection with FIG. 1 have similar reference numbers provided in connection therewith in FIG. 5, incremented by 100, i.e., upper surface 120 in FIG. 1 corresponds to upper surface 220 in FIG. 5. In particular, FIG. 5 illustrates an embodiment of the invention wherein intermediate 200 comprises a carrier 202 having the size of a regular sheet of paper, so as to be easily fed into commercially available computer printers. Generally, intermediate 200 may comprise 8.5″×11″ carrier 202 having fold line 208 that generally extends along a length of carrier 202 thereby defining first panel 224 and second panel 225. First panel 224 has deposited therewithin an area of imprintable material 204, while second panel 225 has deposited thereon visually transparent material 206.

Imprintable material 204 and visually transparent material 206 have three sets of die-cuts 212 and 215, respectively, provided therein that extend through at least imprintable material 204 and visually transparent material 206. As such, die-cuts 212 define three first card portions 214, within the area of imprintable material 204, and die-cuts 215 define three second card portions 216, within the area of visually transparent material 206. Although shown as being the same general shape and size, it is not required that all three, or any, of first card portions 214 be the same, or that all three, or any of second card portions 216 be the same. Rather, all that is required is that each first card portion 214 is substantially the same size and shape as its corresponding second card portion 216, so that when such first and second card portions 214 and 216, respectively, are brought into registered contact to form a laminated card or decal, the edge or periphery of the resulting card or decal is substantially uniform.

Intermediate 200 may be pre-printed to have or ready to have variable and/or fixed indicia imaged thereupon by any of the imaging methods described above in connection with FIG. 1. Advantageously, due to the size of carrier 202, intermediate 200 is configured to be easily fed into a variety of commercially available computer printers, making it easy to utilize intermediate 200 to produce on-demand drivers licenses, employee badges, identification cards, parking decals, membership cards, and the like. In particularly advantageous embodiments, imprintable material 204 would desirably comprise a material imaged by laser or inkjet printing techniques, so that such cards or decals could be produced on-demand, and yet have one or more complex indicia, such as color photographs, logo(s), graphics, biometric code information, or two-dimensional bar codes and the like.

Further, and due at least in part to the size of carrier 202 and the nature of imprintable material 204, any desired fixed or variable indicia could be provided within each first card portion 214, and the indicia so provided could be the same or could be caused to vary from one first card portion 214 to the next. As such, intermediate 200 could be used to produce multiple laminated cards or decals having the same information thereon, or could be used to produce multiple laminated cards or decals with differing indicia, as desired. Once imaged or printed with the desired indicia, intermediate 200 could be subdivided, as desired, and formed into three laminated cards or decals, or could be formed into three laminated cards or decals without subdivision of intermediate 200.

In this regard, then, the present invention further provides an improved and advantageous process of forming a secure intermediate 200. Generally speaking, the method comprises the steps of applying one or more layers of materials constituting bodies 204 and 206 along a length of a carrier supply 202 in first and second positions. A reference line, such as a fold line 208, is determined along a length of the carrier supply 202 so that at least portions of each of said first and second strips of material are positioned on different sides of the line 208. A plurality of die cuts 212 and 215, respectively, are formed through the first and the second bodies 204 and 206 of materials to define a plurality of first and second card portions 214 and 216, respectively, wherein each plurality of card portions is spaced apart from the fold line 208 and so that the second card portions 216 are registrably spaced apart from the fold line 208 with respect to a corresponding first card portion 214. Before and/or after the die cuts have been formed, fixed and/or variable indicia can be provided thereon as desired and the carrier supply 202 divided into a plurality of intermediates, each intermediate having at least one first card portion 214 and at least one second card portion 216.

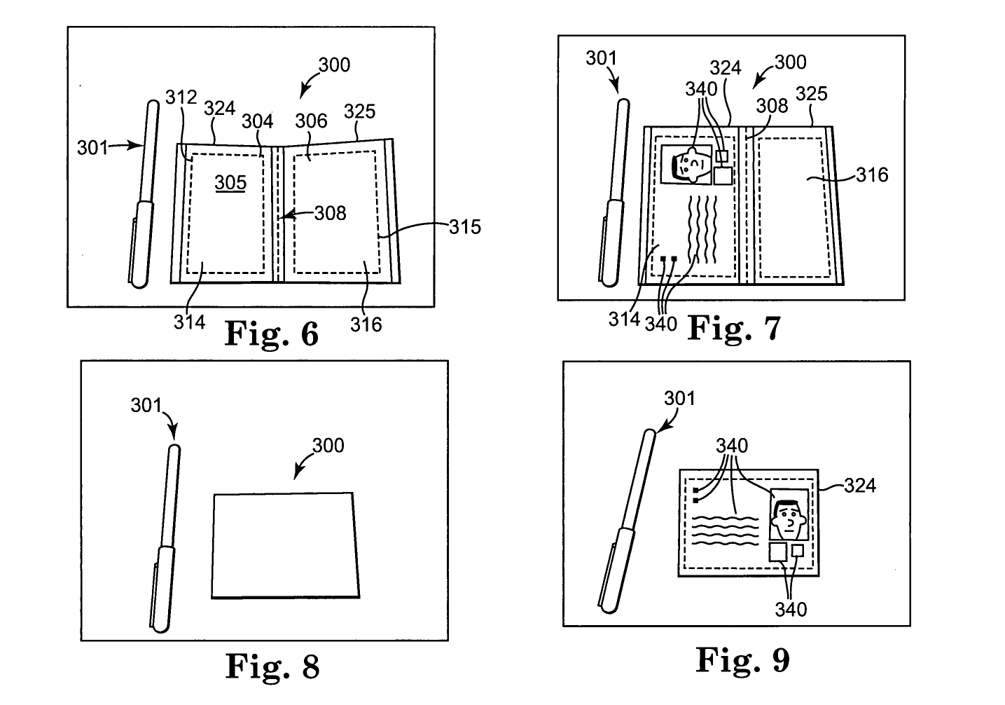

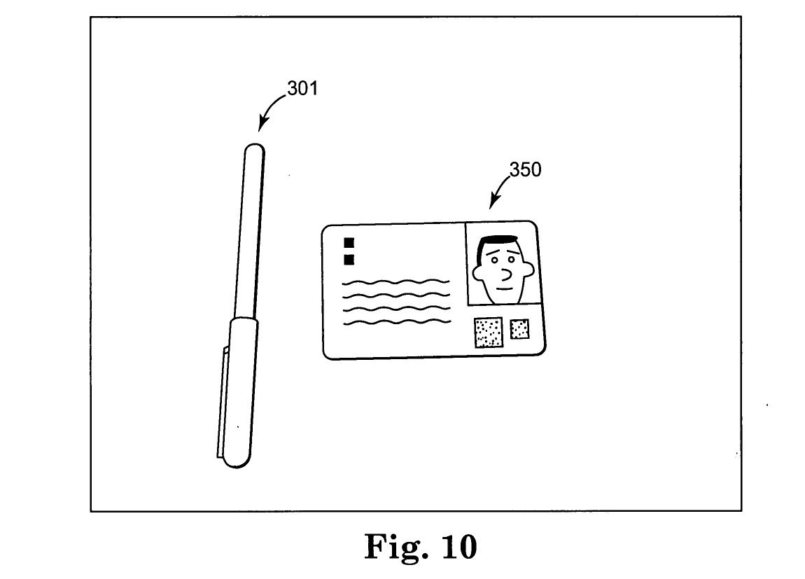

FIGS. 6 through 10 show how an embodiment of the invention having the design of FIGS. 1 and 2 may be used to form an ID card 350. In FIG. 6, an intermediate construction 300 is shown. A typical office pen 301 is shown next to the card for size reference. One side 324 of the intermediate 300 includes a body 304 having a retroreflective, ink receptive surface 305. The other side 325 includes a clear body 306 having a clear, heat sealable adhesive on the surface. Each body 304 and 306 has a die cut 312 and 315, respectively, in it to define first 314 and second 316 card portions. A perforated fold line 308 extends between the card portions. In FIG. 7, the construction 300 has indicia 340 printed onto the ink receptive surface 305. An ink jet printer was used to accomplish this. In FIG. 8, the intermediate 300 is folded along the fold line 308 to bring the card portions 314 and 316 registrably together. This folded construction is then passed through a heat laminating device to laminate the card portions 314 and 316 together. In FIG. 9, the portion of the carrier 302 corresponding to the second panel 325 that originally supported the clear body 306 is peeled away and removed from the rest of the carrier 302 at the perforated fold line 308. The laminated card 350 is now viewable as it is supported upon the remaining first panel portion 324 of the carrier 302. The printed indicia 340 indicative of ID card 350 is viewable through the clear body 306, which now protects the underlying indicia 340. In FIG. 10, the card 350 has been removed from the first panel portion 324 of the carrier 302.

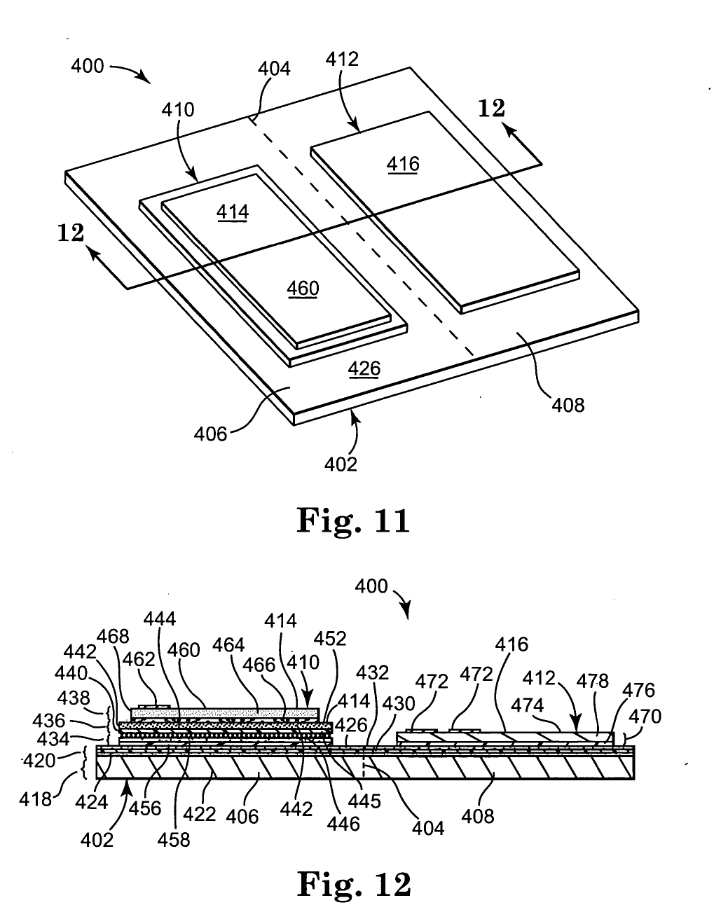

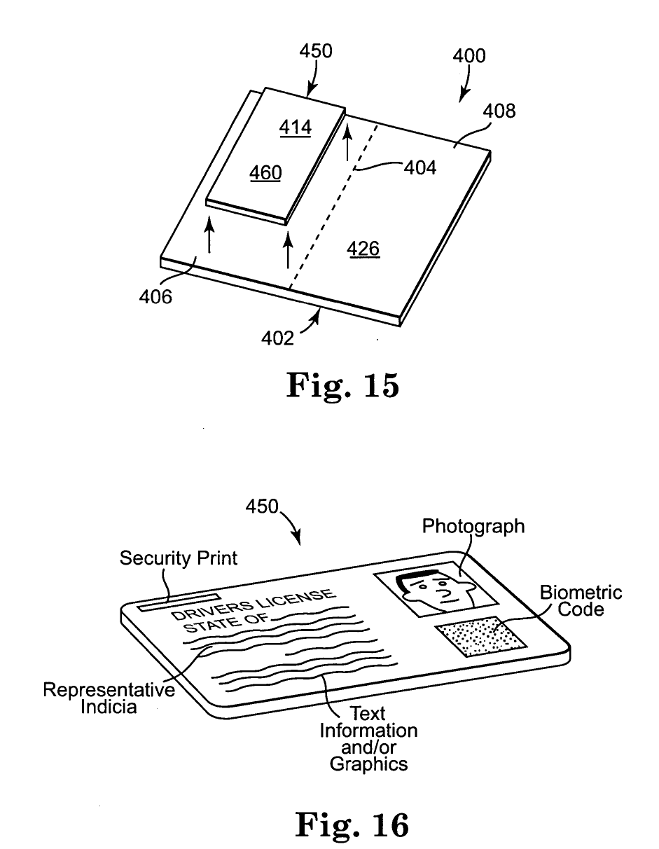

FIGS. 11 through 16 show an alternative embodiment of an intermediate construction 400 of the present invention that is used to form the laminated card 450. Intermediate construction 400 generally includes carrier 402 having a reference line in the form of fold line 404 that divides carrier 402 into first panel 406 and second panel 408. A first card portion 410 is supported upon, and is separate from, first panel 406, while a second card portion 412 is supported, and is separate from, second panel 408. When construction 400 is folded, top surface 414 of first card portion 410 registrably mates with top surface 416 of second card portion 412. The two faces thereby bond (if one or both surfaces includes pressure sensitive characteristics) or are caused to bond together (if, e.g., one or both surfaces includes a heat sealable adhesive) to form laminated card 450. In this particular embodiment, first card portion 410 serves as the base or bottom of the resultant card 450, while second card portion 412 serves as a protective, at least partially transparent cover that overlies first card portion 410 after the card 450 is formed.

Carrier 402 generally includes a carrier base 418 and an adhesion controlling cover 420. Carrier base 418 includes substrate layer 422 and adhesive layer 424. Substrate layer 422 can be formed from any one or more of the film or sheet materials noted above with respect to the intermediate 100 of FIGS. 1 and 2. Preferably, substrate layer 422 is formed from paper or paperboard stock or the like. Adhesive layer 424 helps adhere carrier base 418 to adhesion controlling cover 420 and desirably, therefore, includes a permanent adhesive. Carrier base 418 may be formed from its constituent parts but suitable embodiments in pre-constructed form also are available from commercial sources.

Adhesion controlling cover 420 generally includes a tacky surface 426 by which card portions 410 and 412 can be releasably attached to carrier 402. Adhesion controlling cover 420 is formed from a substrate 430 and an adhesive layer 432 having release characteristics with respect to the card portions 410 and 412. Substrate 430 may be formed from any suitable film or sheet material, but preferably is formed from polyester or polypropylene. Adhesive layer 432 may be cover all or only one or more portion(s) of substrate 430, as desired. Adhesion controlling cover 420 may be formed from constituent parts but also suitable, pre-constructed embodiments are available from commercial sources. As an alternative to cover 420, a suitable composition to achieve desired adhesion or release properties also may be coated onto all or a portion of the carrier surface.

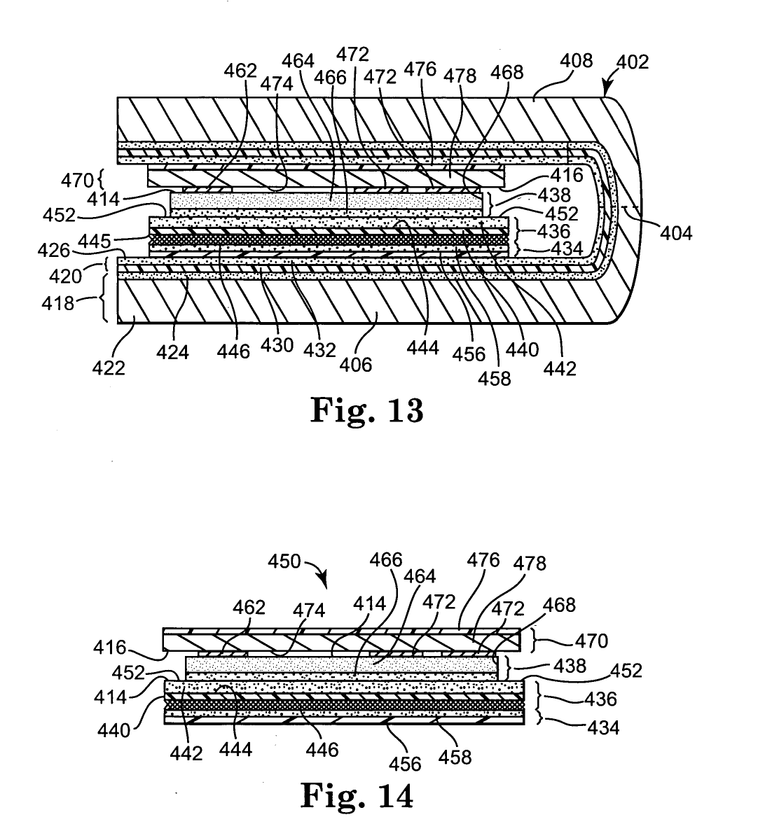

In this embodiment, first card portion 410 serves as the bottom, or base, of resultant card 450 (FIGS. 13 and 14). As such, first card portion 410 may be transparent, partially transparent (e.g., translucent), or opaque. For applications in which card 450 serves as a driver's license, employee badge, or the like, first card portion 410 preferably is opaque.

First card portion 410 generally is formed from a protective backside cover 434, a body portion 436, and an ink receptive body 438. Body portion 436 includes substrate 440 having a heat sealable coating 442 provided on one surface 444. Substrate 440 may be formed from any sheet or film material described herein. In a representative embodiment, substrate 440 is a polyester for which at least surface 445 is, or is rendered (such as by corona discharge or other priming treatment) to be, ink receptive. As such, surface 445 bears optional indicia 446 that may be viewable through backside cover 434. Such indicia 446 may constitute one or more of text, photographs, patterns, graphics, machine readable information, combinations of these, and the like. Indicia 446 may include fixed and/or variable information that covers all or only portion(s) of surface 445. The film or sheet material from which substrate 440 is formed may be opaque or at least partially transparent. In representative embodiments, substrate 440 is opaque, colored, retroreflective, glossy, matte finished, holographic, iridescents, and/or the like and is sufficiently ink receptive so that optional indicia 446 may be formed and visually discerned, if desired.

Heat sealable coating 442 helps to adhere body portion 436 to both ink receptive body 438 as well as second card portion 412. Heat sealable coating 442 includes any suitable heat sealing adhesive and is desirably graphically coordinated in some fashion with the overlying ink receptive body 438, inasmuch as shoulder 452 of surface 444 is exposed around the periphery of surface 444 and is viewable when card 450 is formed. Body portion 436 may be formed from its constituent parts but also suitable, pre-constructed embodiments are available from commercial sources.

Protective backside cover 434 is generally at least partially transparent to allow indicia 446 to be viewed and includes at least partially transparent, protective film 456 and adhesive layer 458 that bonds film 456 to body portion 436. Protective film 456 is desirably formed from any suitable material such as polyester, polypropylene, polycarbonate, (meth)acrylic copolymers, polyurethanes, combinations of these, and the like. Adhesive layer 458 generally includes a permanent adhesive to durably attach film 456 to body portion 436. As with other components, backside cover 434 may be formed from its constituent parts but also suitable, pre-constructed embodiments are available from commercial sources.

Ink receptive body 438 provides surface 460 on which fixed and/or variable indicia 462 can be easily printed on demand before intermediate 400 is folded to registrably mate and laminate card portions 410 and 412 to each other. Ink receptive body 438 generally includes printable layer 464 and adhesive layer 466 that bonds ink receptive body 438 to body portion 436. Adhesive layer 466 desirably includes a permanent adhesive. Printable layer 464 generally is formed from an ink receptive paper or film on which indicia 462 can be formed using laser printing, ink jet printing, screen printing, or any other desired printing technique.

Ink receptive body 438 is undersized relative to underlying body portion 436 to thereby establish shoulder 452 around the periphery of ink receptive body 438. Exposed shoulder 452 not only makes fabrication of first card portion 410 easier (described below), but also helps to ensure a durable peripheral bond between first and second card portions 410 and 412 when the two portions are laminated to each other. Sidewall 468 of ink receptive body 438 forms a step between shoulder 452 and surface 460. In FIG. 13, the height of sidewall 468 is exaggerated for illustration purposes. In actual practice, the height is sufficiently small so that second card portion 412 is readily laminated to both ink receptive body 438 and shoulder 452 in a manner such that sidewall 468 is barely tactiley discernible, if at all, through second card portion 412. Ink receptive body 438 may be formed from its constituent parts but also suitable, pre-constructed embodiments are available from commercial sources.

Second card portion 412 is releasably attached to second panel 408 of carrier 402 and generally includes transparent cover 470. Optional indicia 472, which may include fixed or variable information on all or a portion of surface 474, may be imaged onto surface 474 using any desired printing or imaging technique, as desired. Transparent cover 470 includes film 476 and heat sealable coating 478. Transparent cover 470 is sufficiently transparent to allow indicia 472 on second card portion 412 and indicia 462 on first card portion 410 to be viewed through transparent cover 470 after card 450 is formed. Heat sealable coating 478 may be formed from any suitable heat sealable adhesive, and film 476 may be formed from any suitable film or sheet material that is as transparent as desired and that helps to protect indicia 472 and 462 from wear and tampering. Clear polyester is a preferred material for forming film 476. Transparent cover 470 may be formed from its constituent parts but also suitable, pre-constructed embodiments are available from commercial sources.

One or more optional security features may be incorporated into intermediate 400 or any construction embodiment of the invention to help prevent tampering and to help indicate a tampering event. For instance, any of the indicia incorporated into either first or second card portions may be formed with holographic foil, hidden inks that are only visible under certain conditions, heat sensitive or thermochromic inks, photochromic inks, color shifting inks, iridescent ink, combinations of these, or the like. Additionally, physical components such as passive or active transponders, magnetic stripes, microtagants, unique molecules, holographic thread, combinations of these, and the like may also be used. Special images may also be formed such as holograms, two dimensional, machine readable images, hidden or viewable watermarks, microscopic images, lenticular images, laser-viewable images, covert or overt, holography, combinations of these, and the like.

According to one representative mode of making intermediate 400, desired indicia 446 is printed or otherwise applied onto surface 445 of a pre-constructed length of material corresponding to body portion 436. Then, a pre-constructed length of material corresponding to backside cover 434 is laminated to the length of material corresponding to body portion 436 overlying indicia 446. The resultant subassembly of laminated body portion 436 and backside cover 434 material will be used as described below.

Optionally, a portion or all of fixed or variable indicia 462 is printed or otherwise applied onto surface 460 of a pre-constructed length of material corresponding to ink receptive body 438. With indicia 462 facing in one direction and indicia 446 facing in the other, the subassembly of laminated body portion 436 and backside cover 434 is laminated to the pre-constructed length of material corresponding to ink receptive body 438. The resultant assembly is die cut through the pre-constructed length of material corresponding to ink receptive body 438 to define a plurality of ink receptive bodies 438 supported upon the as yet uncut, subassembly of laminated body portion 436 and backside cover 434 material. The outer waste (weed) of ink receptive body material is removed and may be discarded.

Next, optionally a portion or all of indicia 472 is printed or otherwise applied onto surface 474 of a pre-constructed length of material corresponding to second card portion 412. This printed assembly is then applied onto a carrier web on one side of a designated reference line that corresponds to the fold line of the resultant intermediate constructions. The other assembly having the die cut through the pre-constructed length of material corresponding to ink receptive body 438 supported upon the as yet uncut, subassembly of laminated body portion 436 and backside cover 434 material is applied onto the carrier web on the other side of the reference line. Die cuts are then made to define a plurality of first card portions 410 and second card portions 412 supported on the carrier 402. The waste (weed) is removed. The reference line is also scored, perforated, or otherwise treated so as to become fold line 404. Preferably, die-cuts defining card portions 410 and 412 as well as perforations/scoring establishing fold line 404 are formed at the same time with the same die to ensure accuracy in placement of these features with respect to each other. The resultant product may then be further subdivided into one or more separate intermediate construction forms of the present invention, each such form including at least one first card portion and at least one, corresponding second portion.

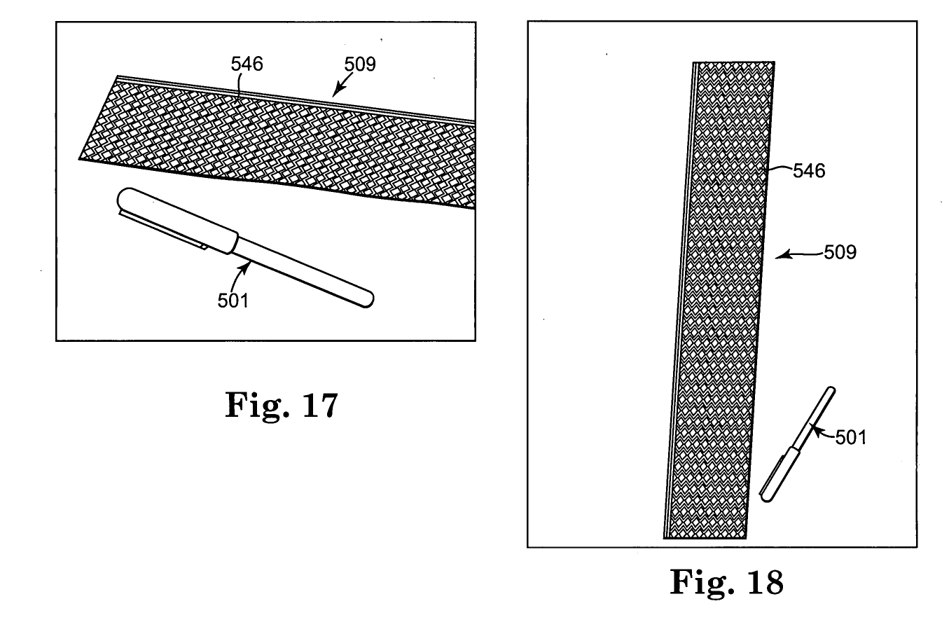

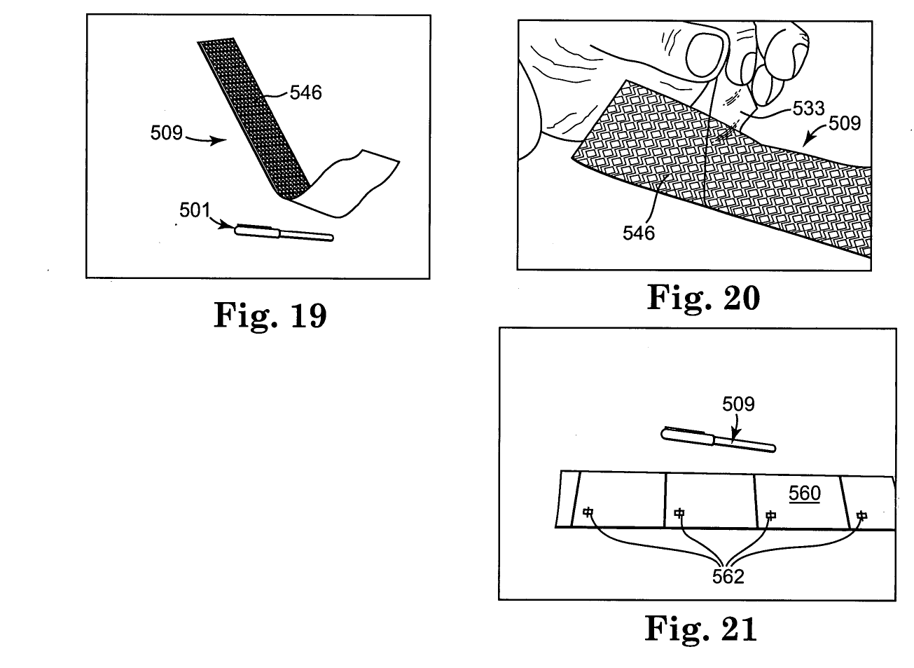

FIGS. 17 through 34 show how an embodiment of the invention having the design of FIGS. 11-16 may be fabricated and then used to form an ID card 550. In FIGS. 17-20, a length of material constituting a subassembly 509 of protective backside cover and body portion materials laminated to each other is shown. A pen 501 is positioned next to the material for a scale reference. Indicia 546 in the form of a pattern are printed onto the surface of the body portion material. The protective backside cover material overlies and protects the indicia 546 as well as the body portion material. Printed security/authenticity features (not shown) optionally may be printed into the pattern. In FIG. 19, the end of the material is curled over to show the other heat sealable adhesive surface. In FIG. 20, a portion of the protective backside cover material 533 is peeled away to show how it overlies the body portion material. FIG. 21 a pre-printed ink receptive body material that will be laminated to the material of FIGS. 17-20. The ink receptive surface 560 of the material is viewable. Authenticity symbols 562 have been pre-printed in the areas of the material that will correspond to corners of first card portions 510 that will be subsequently formed. For reference purposes, vertical lines have been applied onto the ink receptive purposes for reference purposes only in order to approximately identify boundaries between the first card portions 510 to be subsequently formed.

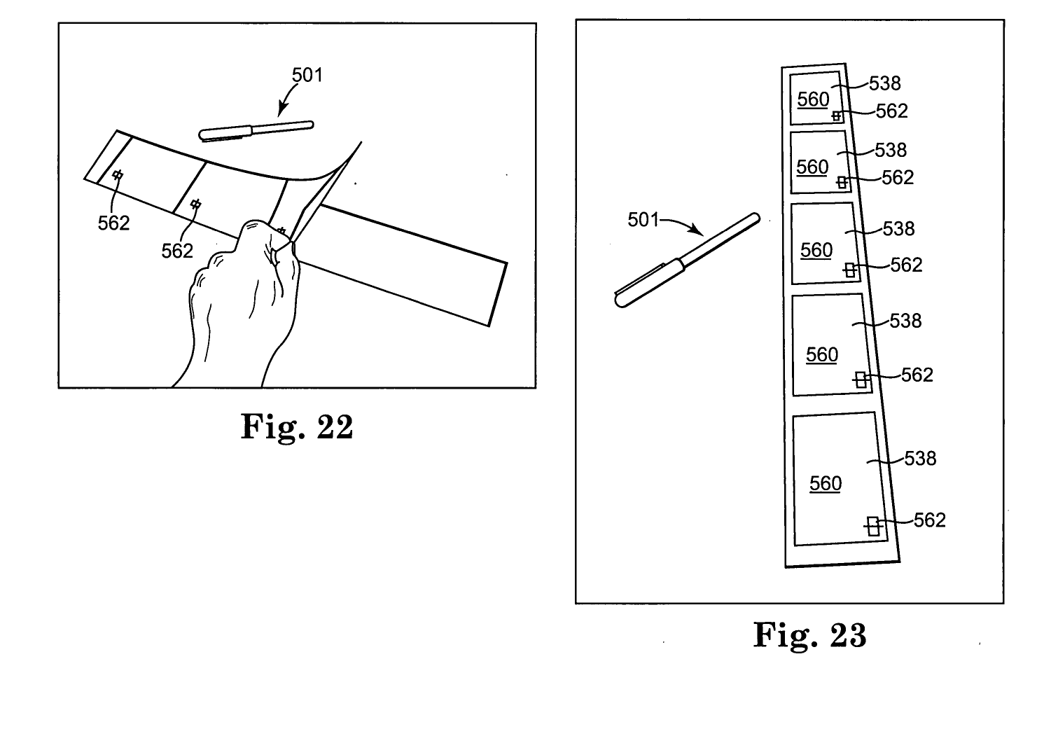

FIG. 22 shows how the materials of FIGS. 17-20 and 21 are positioned when laminated together.

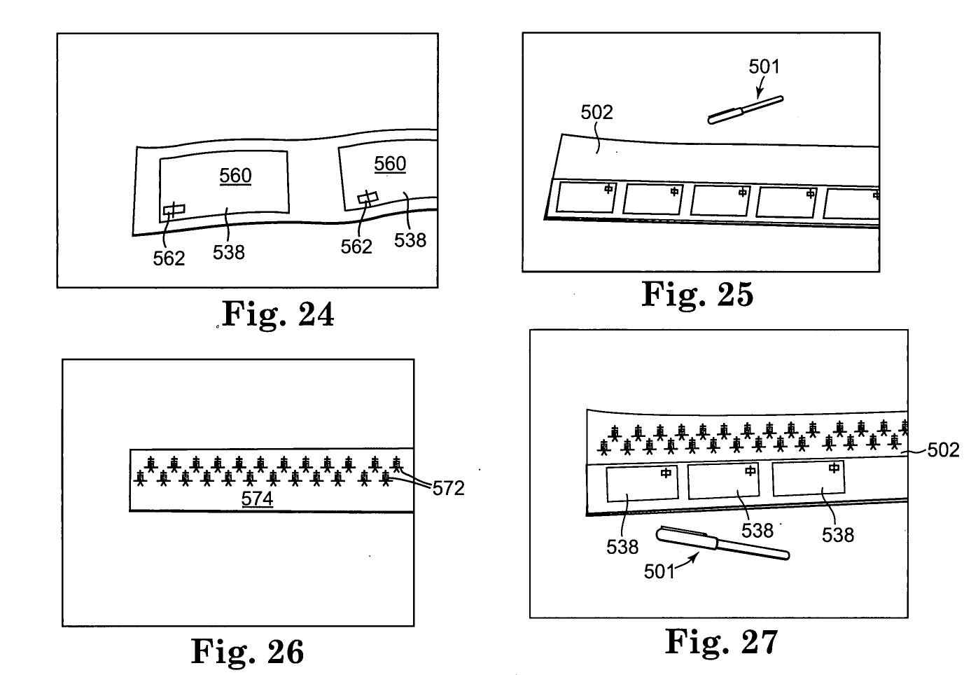

FIGS. 23 and 24 show how the laminated subassembly resulting from FIG. 22 is subjected to a first die cutting operation in which die cuts defining a plurality of ink receptive bodies 538 having surfaces 560 are formed down the length of the ink receptive body material with the resulting weed having been removed. The pre-printed indicia 562 are viewable in the corner of each body portion. At this stage, a further die cut does not yet extend through the underlying body portion material or protective backside cover material. Such additional die cut will be formed subsequently, as explained below.

In FIG. 25, the die-cut assembly of FIGS. 23 and 24 is applied to one side of a carrier 502.

FIG. 26 shows a pre-printed length of material from which second card portions 512 will be formed. The top surface 574 is a heat sealable, clear adhesive. Indicia 572 in the form of security symbols is printed directly onto this surface 574. FIG. 27 shows the material of FIG. 26 applied onto the other side of the carrier 502 of FIG. 25 relative to the die-cut assembly of FIGS. 23 and 24. Once both materials are supported on the carrier 502, die cutting and perforation, as the case may be, is advantageously carried out to define first card portions 510, second card portions 512, and fold line 504 along the length of the assembly. Preferably, these are formed using the same die so that these features are positioned accurately with respect to each other. The die cut used to form the first card portions 510 matches the die cut used to from the second card portions 512 so that the two have the same peripheral dimensions. However, the die cut used to form the first card portion 510 is oversized relative to the earlier die cut used to form the ink receptive bodies 538. In this way, a shoulder portion of the underlying, heat sealable surface of the body portion is exposed around the periphery of the ink receptive bodies 538. This exposed shoulder mates with and forms a durable, water resistant seal with the corresponding card portion during the lamination step (described below).

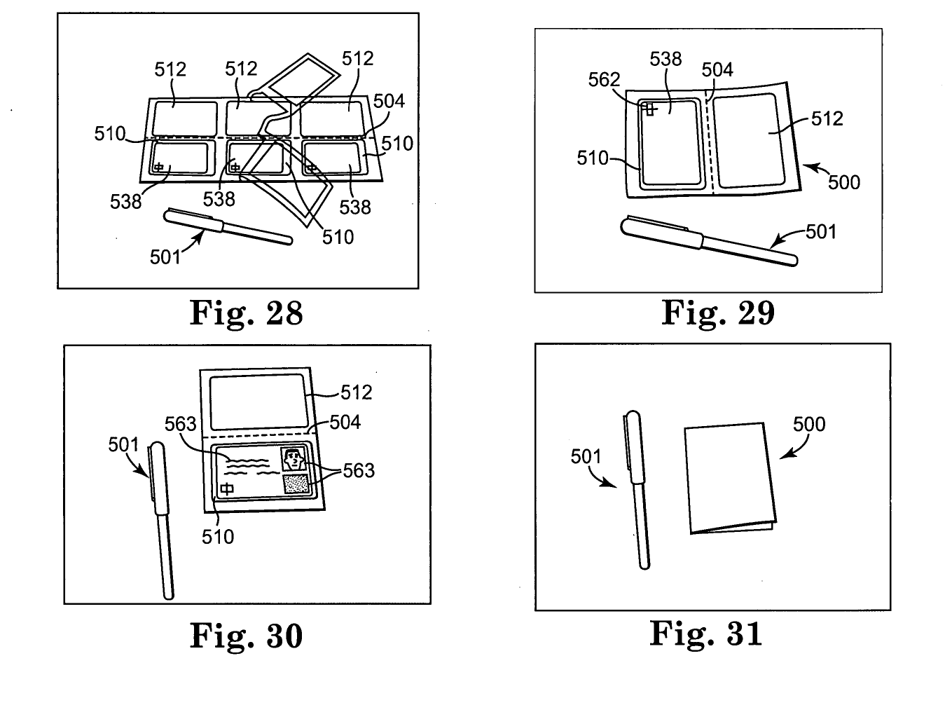

FIG. 28 shows the assembly after such die cutting with a portion of the weeds 555 pulled back. The respective first 510 and second 512 card portions remain supported on the carrier 502.

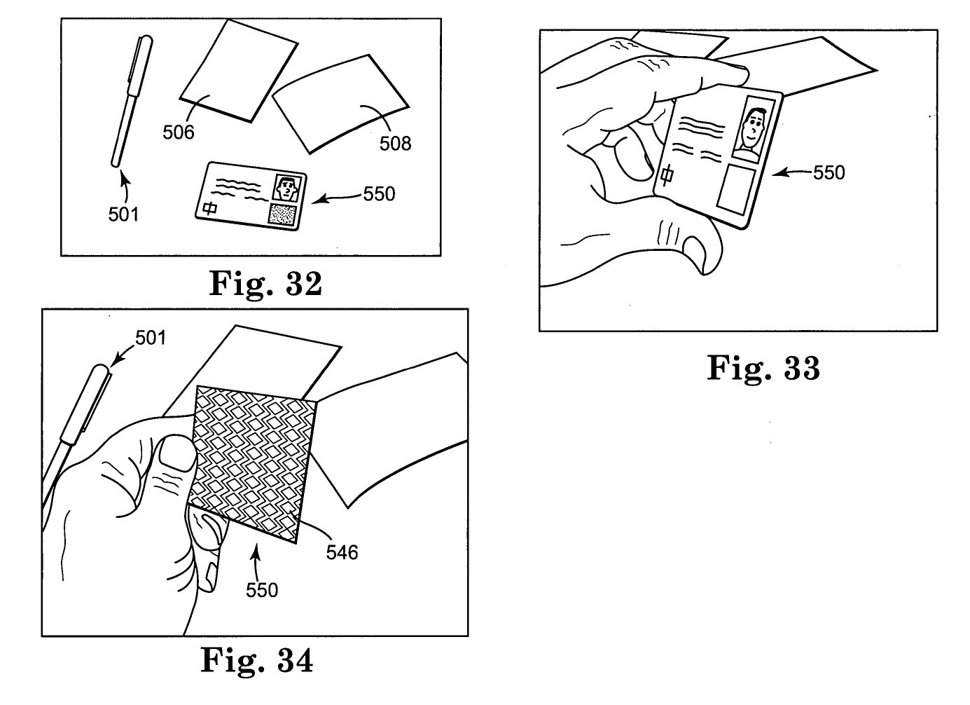

FIG. 29 shows an intermediate 500 separated from the structure of FIG. 28. Corresponding first 510 and second 512 card portions are supported on the underlying carrier 502. In FIG. 30, indicia 563 indicative of an ID card is printed onto the ink receptive surface 560 of the first card portion 510. In FIG. 31, the intermediate 500 is folded to registrably mate the first 510 and second 512 card portions. The folded structure is processed in a laminating machine to bond the card portions together. In FIG. 32, the resultant card 550 is removed from the carrier panels 506 and 508, which may be discarded. FIG. 33 is a perspective view of the front face of the card 550. The identification indicia is viewable. FIG. 34 is a perspective view of the backside of the card 550. The pattern 546 is viewable.

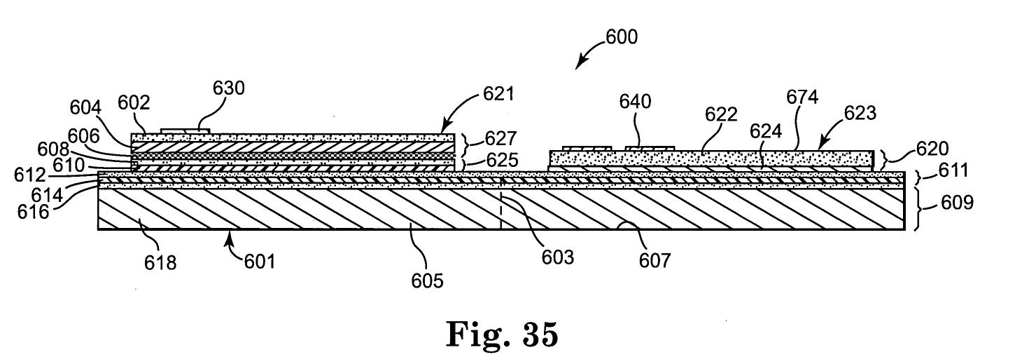

FIG. 35 shows a schematic, side cross-sectional view of an alternative intermediate 600 of the present invention. Intermediate 600 is similar to intermediate 400, but has a simplified first card portion 621 structure. Intermediate 600 also incorporates an advantageous second card portion 623 feature that enhances water resistance of the resultant laminated card (not shown) formed from intermediate 600. In more detail, carrier 601 has fold line 603 dividing carrier 601 into first panel 605 and second panel 607. The entirety of carrier 601 is formed from a base 609 and an adhesion controlling layer 611. Base 609 is formed from a substrate 618 and permanent adhesive layer 616. Adhesion controlling layer 611 in this embodiment is formed from film or sheet 614 and release coating or layer 612, but the desired release or adhesion characteristics may also be provided by a coating applied onto all or portions of substrate 609.

A first card portion 621 is supported upon, and is separate from, first panel 605, while a second card portion 623 is supported upon, and is separate from, second panel 607. When construction intermediate 600 is folded, the top surface of first card portion 621 registrably mates with the top surface of second card portion 623. The two surfaces thereby bond (if one or both surfaces includes pressure sensitive characteristics) or are caused to bond together (if, e.g., one or both surfaces includes a heat sealable adhesive) to form a laminated card.

First card portion 621 is formed from protective backside cover 625 and ink receptive body 627. Backside cover 625 includes clear film or sheet layer 610 that helps to protect the underside of the resultant laminated card and permanent adhesive layer 608 that helps bond backside cover 625 to ink receptive body 627. Ink receptive body 627 includes film or sheet layer 604 and an ink receptive coating layer 602. Indicia 630 is printed onto the top surface of ink receptive body 627, while indicia 606 is printed onto the underside of layer 604. After the resultant laminated card is formed, indicia 630 is viewable through second card portion, while indicia 606 is viewable through protective backside cover 625. Ink receptive body 627 and backside cover 625 are the same areal dimension, so both can be die cut at the same time. This differs from the process used to make intermediate 400 described above, where two die cut steps were used so that ink receptive body 438 could be slightly undersized relative to other constituents of first card portion 410.

Second card portion 623 is releasably attached to second panel 607 of carrier 601 and generally includes transparent cover 620. Optional indicia 640, which may include fixed or variable information on all or a portion of the top surface of second card portion 623, may be imaged onto surface 674 using any desired printing or imaging technique, as desired. Transparent cover 620 includes film or sheet 624 and adhesive layer 622 which may have heat sealable adhesive characteristics, pressure sensitive adhesive characteristics, and/or the like. Advantageously, second card portion 623 is slightly oversized in areal dimension relative to first card portion 621 so that the outer peripheral portion of heat sealable coating layer 622 wraps over the periphery of first card portion 621 to some degree during lamination. This advantageously enhances the bond integrity between the card portions 621 and 623, and hence the water resistance of the bond is enhanced.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

1. A card intermediate, comprising:
a carrier comprising an upper surface, a lower surface and a fold line defining first and second panels;
at least one first card portion comprising imprintable material and provided on the first panel and such that the at least one first card portion is spaced apart from the fold line;
at least one second card portion comprising at least partially transparent material having an upper surface and lower surface and provided on the second panel such that the at least one second card portion is spaced apart from the fold line in a position such that the second card portion registrably contacts the first card portion when the carrier is closed along the fold line, and wherein at least one of the card portions bears an adhesive to allow lamination of the card portions to each other.

2. The card intermediate of claim 1, wherein the first card portion further comprises a permanent adhesive between the imprintable material and the carrier.

3. The card intermediate of claim 2, wherein the second card portion further comprises:
a heat sealable adhesive provided on the upper surface of the at least partially transparent material;
a film between the at least partially transparent material and the carrier;
a releasable adhesive between the at least partially transparent material and the film; and
a permanent adhesive between the film and the carrier.

4. The card intermediate of claim 3, wherein the heat sealable adhesive provided on the upper surface of the at least partially transparent material is imprintable.

5. The card intermediate of claim 1, wherein the carrier comprises:
a carrier base comprising an upper and lower surface; and
an adhesion controlling cover provided on the upper surface of the carrier base such that the at least one first and second card portions are releasably attached to the carrier.

6. The card intermediate of claim 5, wherein the first card portion comprises:
a protective backside cover releasably attached to the carrier;
an ink receptive body comprising the imprintable material, having an upper and lower surface, and positioned above the protective backside cover; and
a body portion positioned between and attached to the protective backside cover and the ink receptive body; and, wherein the second card portion comprises a transparent cover releasably attached to the carrier, wherein the transparent cover comprises:
an at least partially transparent film having an upper and lower surface and releasably attached to the carrier; and
a heat sealable adhesive having an upper surface and a lower surface, and attached to the upper surface of the at least partially transparent film.

7. The card intermediate of claim 6, further comprising indicia provided on the upper surface of the ink receptive body.

8. The card intermediate of claim 7, wherein the ink receptive body is undersized relative to the underlying body portion, thereby establishing a shoulder around the periphery of ink receptive body.

9. At least one card formed form the card intermediate of claim 8, wherein the shoulder portion of the underlying body portion mates with the second card portion so as to form a water resistant seal.

10. The card intermediate of claim 8, wherein the heat sealable adhesive comprises:
imprintable material; and
indicia provided on the upper surface of the heat sealable adhesive.

11. The card intermediate of claim 10, wherein the surface of the body portion facing the protective backside cover comprises:
imprintable material; and
indicia provided on the surface of the body portion facing the protective backside cover.

12. The card intermediate of claim 5, wherein the first card portion comprises:
a protective backside cover having a first and second major surface, wherein the second major surface is releasably attached to the carrier; and
an ink receptive body comprising the imprintable material and having an upper and lower surface, wherein the ink receptive body is attached to the first major surface of the protective backside cover; and, wherein the second card portion comprises a transparent cover releasably attached to the carrier, wherein the transparent cover comprises:
an at least partially transparent film releasably attached to the carrier; and
a heat sealable adhesive attached to the top surface of the at least partially transparent film.

13. The card intermediate of claim 12, further comprising indicia provided on the upper surface of the ink receptive body.

14. The card intermediate of claim 12, wherein the ink receptive body and the protective backside cover have the same areal dimension.

15. The card intermediate of claim 14, wherein the second card portion is oversized in areal dimension relative to the first card portion.

16. At least one card formed form the card intermediate of claim 15, wherein the first card portion mates with the first card portion to form a water resistant seal.

17. The card intermediate of claim 1, wherein the carrier is 8.5 inches wide and 11 inches long, and wherein the fold line extends along the length of the carrier.

18. At least one card formed form the card intermediate of claim 1.

19. The at least one card of claim 18, comprising a driver's license.

20. A method of making a card intermediate, comprising the steps of:
applying a first strip of material onto an upper surface of a carrier supply in a first position, the first strip generally extending along a length of the carrier;
applying a second strip of material onto the upper surface of the carrier supply in a second position, the second strip generally extending along a length of the carrier and being generally parallel to the first strip of material;
determining a reference line along a length of the carrier supply such that at least portions of each of the first and second strips of material are positioned on different sides of the reference line;
forming at least one die cut at least through the first strip of material in a manner effective to define at least one first card portion, the first card portion being spaced apart from the reference line; and
forming at least one die cut at least through the second strip of material in a manner effective to define at least one second card portion, the second card portion being registrably spaced apart from the fold line with respect to the corresponding first card portion.

21. The method of claim 20, wherein the step of forming at least one die cut at least through the first strip of material comprises forming a plurality of die cuts at least through the first strip of material in a manner effective to define a plurality of first card portions, said first card portions being spaced apart from the reference line, and wherein the step of forming at least one die cut at least through the second strip of material comprises forming a plurality of die cuts at least through the second strip of material in a manner effective to define a plurality of second card portions, the second card portions being registrably spaced apart from the fold line with respect to the corresponding first card portion.

22. The method of claim 21, further comprising the step of after forming the die cuts at least through the first and second strips, dividing the carrier supply into a plurality of card intermediates, each card intermediate comprising at least one first card portion and at least one second card portion.

23. The method of claim 20, further comprising the steps of:
after the step of applying a first strip of material, applying a third strip of material onto an upper surface of the first strip of material, the third strip generally extending along a length of the carrier; and
after the determining step, forming at least one die cut at least through the third strip of material in a manner effective to define an areal dimension of the third material less than the first card portion and an areal boundary within the first card portion.

24. The method of claim 20, wherein the areal dimension of the second card portion is greater than the areal dimension of the first card portion.

25. A method of making a laminated card, comprising the steps of:
providing a card intermediate, said card intermedia comprising:
a carrier comprising an upper surface, a lower surface and a fold line defining first and second panels;
at least one first card portion comprising imprintable material and provided on the first panel such that the at least one first card portion is spaced apart from the fold line;
at least one second card portion comprising at least partially transparent material having an upper surface and lower surface and provided on the second panel such that the at least one second card portion is spaced apart from the fold line in a position such that the second card portion registrably contacts the first card portion when the carrier is closed along the fold line, and wherein at least one of the card portions bears an adhesive to allow lamination of the card portions to each other;
providing visually discernible information on at least one of the first and second card portions;
folding the carrier along the fold line under conditions effective to registrably laminate the first card portion to the second card portion, thereby forming a laminated card; and
removing the laminated card from at least a portion of the carrier.
